(19) United States
(12) Patent Application Publication
(10) Pub. No.: US 2023/0409788 A1
(43) Pub. Date: Dec. 21, 2023

(54) SYNCHRONIZING DISTRIBUTED SIMULATIONS OF A CIRCUIT DESIGN

(71) Applicant: Synopsys, Inc., Mountain View, CA (US)

(72) Inventors: Parijat BISWAS, Bangalore (IN); Sitikant SAHU, Bangalore (IN); Tilak Chand Vinay Kumar MEKA, Kothaguda (IN); Shivani JAIN, Bangalore (IN)

(21) Appl. No.: 17/845,403

(22) Filed: Jun. 21, 2022

(51) Int. Cl. G06F 30/3308; G06F 9/52

(52) U.S. Cl. CPC G06F 30/3308; G06F 9/52; G06F 2111/02

(57) ABSTRACT

A system and method for using a distributed simulation system includes simulating a first portion of the circuit design within a first simulation environment by a first client device to generate first simulation data. Further, a second portion of the circuit design is simulated within a second simulation environment by a second client device to generate second simulation data. The first simulation data and the second simulation data are generated asynchronously with each other. Further, the first simulation data and the second simulation data are received at a primary client device synchronously with each other.

### TECHNICAL FIELD

The present disclosure generally relates to an electronic design automation (EDA) system, and, more particularly, to a system and method for synchronizing distributed simulations of a circuit design.

### BACKGROUND

Circuit designs are simulated to verify the functionality of the circuit designs. Distributed simulation models are applied to the circuit designs to decrease the amount of time used to simulate a circuit design. Distributed simulation models are applied to circuit designs that include multiple integrated circuit (IC) chips (or dies), artificial intelligence (AI) chips, and large processor designs to decrease the time spent during simulation. In a distributed simulation model, different portions of a circuit design are simulated by different client devices.

### SUMMARY

A method includes receiving a circuit design, and simulating a first portion of the circuit design within a first simulation environment by a first client device to generate first simulation data. The method further includes simulating a second portion of the circuit design within a second simulation environment by a second client device to generate second simulation data. The first simulation data and the second simulation data are generated asynchronously with each other. Further, the method includes receiving the first simulation data and the second simulation data at a primary client device. The first simulation data and the second simulation data are received by the primary client device synchronously with each other. Further, functionality of the circuit design is determined based on the first simulation data and the second simulation data.

A system includes a first client device, a second client device, and a third client device. The first client device simulates a first portion of a circuit design within a first simulation environment to generate first simulation data. The second client device simulates a second portion of the circuit design within a second simulation environment to generate second simulation data. The first simulation data and the second simulation data are generated asynchronously with each other. A third client device receives the first simulation data and the second simulation data from the first client device and the second client device synchronously with each other. Functionality of the circuit design is determined based on the first simulation data and the second simulation data.

A non-transitory computer readable medium comprising stored instructions. When the instructions are executed by one or more processors, the instructions cause the one or more processors to receive a circuit design including a first local clock signal, and a second local clock signal, and a primary clock signal. The one or more processors simulate a first portion of the circuit design within a first simulation environment to generate first simulation data based on the first local clock signal. Further, the one or more processors simulate a second portion of the circuit design within a second simulation environment to generate second simulation data based on the second local clock signal. The one or more processors further receive the first simulation data and the second simulation data synchronously with each other and based on the primary clock signal. The first simulation data and the second simulation data are generated asynchronously with the primary clock signal and each other. Functionality of the circuit design is determined based on the first simulation data and the second simulation data.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a block diagram of a circuit simulation system, according to one or more examples.

FIG. 2 illustrates a method for synchronizing simulations of a distributed simulation process, according to one or more examples.

FIG. 3 illustrates connections of a configuration file, according to one or more examples.

FIG. 4 illustrates clock signal waveforms, according to one or more examples.

FIG. 5A and FIG. 5B illustrate a phase diagram of simulation environments, according to one or more examples.

FIG. 6 illustrates a waveform of a primary clock signal and corresponding read and write requests, according to one or more examples.

FIG. 7 illustrates phases associated with different testbenches, according to one or more examples.

FIG. 8 depicts a flowchart of various processes used during the design and manufacture of an integrated circuit in accordance with some embodiments of the present disclosure.

FIG. 9 depicts a diagram of an example emulation system in accordance with some embodiments of the present disclosure.

FIG. 10 depicts a diagram of an example computer system in which embodiments of the present disclosure may operate.

### DETAILED DESCRIPTION

Aspects of the present disclosure relate to synchronize distributed simulations of a circuit design.

Distributed simulation is used to simulate different portions of the circuit design with different client devices. In one example, a circuit design may include multiple integrated circuit (IC) chips (or dies). In such an example, the circuit design may be partitioned such that each IC chip is a different partition (e.g., portion). In such an example, each IC chip is simulated by a different client device. In other examples, a circuit design is partitioned in other ways. For example, an IC chip may be partitioned in to a plurality of partitions. Further, a circuit design may be analyzed to determine how to partition a circuit design. A circuit design may be partition to balance the size of the design. A circuit design may be partitioned dynamically based on simulation times of the different parts of a circuit design. Each partition is simulated by a different client device. The simulations performed by the different client devices are performed in parallel with each other, such that at least a portion of the simulations occur during an overlapping period of time. As a distributed simulation process employs overlapping simulations, a distributed simulation process uses less processing time, improves runtime capacity, and runtime performance of the corresponding circuit simulation system as compared to circuit simulation system that does not employ a distributed simulation process. Further, in a distributed simulation process, multiple IC chips can be simulated without having to integrate all of the IC chips within a single system-on-chip (SoC).

Generally, in distributed simulation processes, as data is communicated between the simulations, the simulations are closely synchronized with each other. During the simulation process, there are periods during which the simulations are performed un-obstructed with each other, and periods during which the simulations are synchronized with each other to communicate data between the simulations. However, current synchronization processes suffer from issues that negatively affect the circuit design simulation process. For example, current synchronization processes may under synchronize the distributed simulations, which may lead to an incorrect determination of the functionality of the circuit design under test. In other instances, current synchronization processes may over synchronize the distributed simulations, increasing the processing power requirements and/or processing time.

As described herein, the present synchronization system and method for distributed simulation improves the ability for the distributed simulation process to deal with synchronous and asynchronous events that occur during the simulations of the distributed simulation process, and simulations that operate at different speeds. The synchronization process described in the following allows each simulation to run asynchronously with each other for the majority of the simulation time, synchronizing the simulations at the completion of common simulation phases and/or selectively based on a primary clock signal (e.g., synchronization signal or sync signal).

Technical advantages of the present disclosure include, but are not limited to, a synchronization process that improves the ability for the distributed simulation process to deal with synchronous and asynchronous events, and simulations that operate at different speeds. The synchronization process of the present disclosure uses less processing resources and/or processing time as compared to other synchronization processes, and improves the ability of a distributed simulation process to accurately determine the functionality of a circuit design. Further, the synchronization process of the present disclosure allows each simulation to run asynchronous with each other for the majority of the simulation time, synchronizing the simulations at the completion of common simulation phases and/or selectively based on a primary clock signal. While some simulation processes may use distributed simulation processes, if asynchronous events occur, the simulation can become non-deterministic, and provide a non-deterministic result, when there is a timing (e.g., speed) difference between the distributed simulations. However, the present distributed simulation system and method provides a deterministic result regardless of a timing difference between the distributed simulations by maintaining a common synchronization clock signal across the distributed simulations, and by allowing the writes of the distributed simulations to be asynchronous with each other and ensuring that the reads of the distributed simulations are synchronous to the synchronization clock signal. Further, the testbench phases of the present distributed simulation system and method are synchronized across the various simulation through the use of wait commands within the testbenches, and not synchronized based on simulation time.

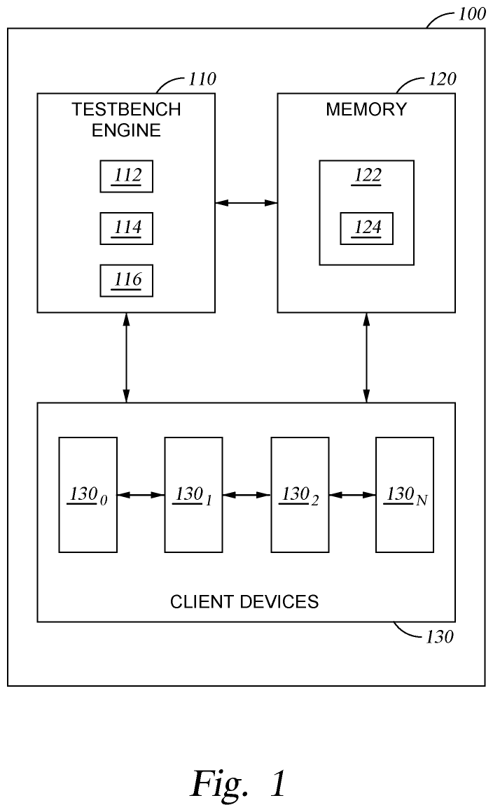

FIG. 1 illustrates a circuit simulation system 100, according to one or more examples. The circuit simulation system 100 simulates a circuit design (e.g., the circuit design 122) to verify the functionality of the circuit design using a distributed simulation process. The circuit simulation system 100 partitions the circuit design into multiple partitions that are simulated separate from one another. The circuit simulation system 100 generates simulation data from the simulation of each partition and combines the simulation data to determine the functionality of the circuit design.

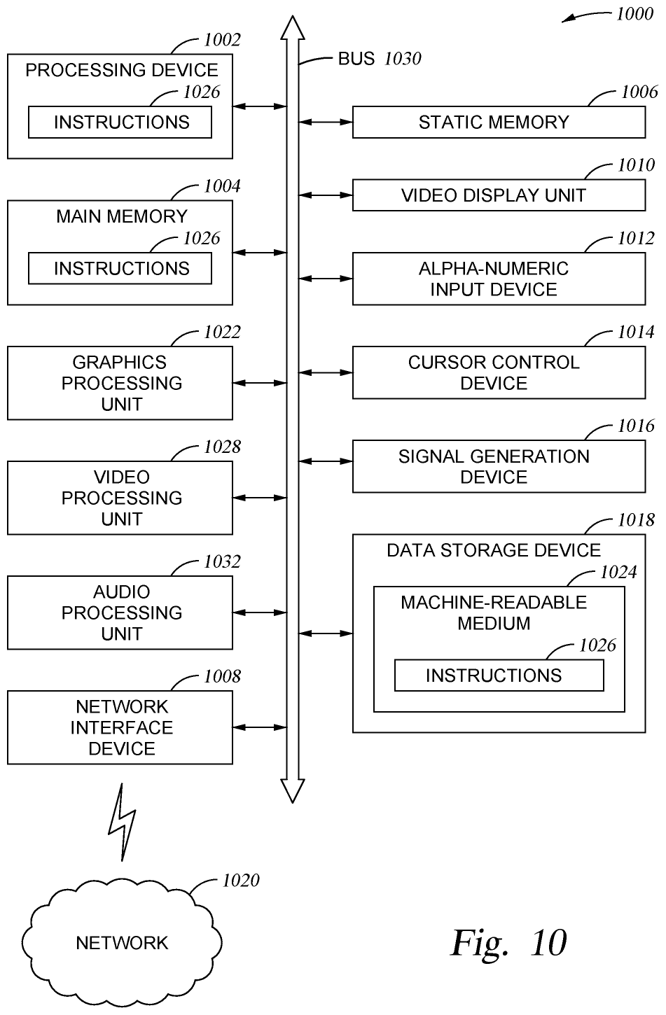

The circuit simulation system 100 includes one or more processors (e.g., the processing device 1002 of FIG. 10) that execute instructions (e.g., instructions 1026 of FIG. 10), stored memory (e.g., memory 120, the main memory 1004, and/or machine-readable medium 1024 of FIG. 10) to simulate and determine the functionality of a circuit design.

The circuit simulation system 100 includes a testbench engine 110, a memory 120 and client devices 130. The testbench engine 110 includes one or more processors (e.g., the processing device 1002 of FIG. 10) that execute instructions (e.g., instructions 1026 of FIG. 10), stored memory (e.g., memory 120, the main memory 1004, and/or machine-readable medium 1024 of FIG. 10). The testbench engine 110 includes a verification engine 112 and a debug engine 114. In one or more examples, one or more of the processors of the testbench engine 110 execute instructions associated with the verification engine 112 and/or the debug engine 114. The verification engine 112 receives the circuit design 122 from the memory 120, or a system external to the circuit simulation system 100.

The circuit design 122 describes the circuit components and logical operations performed by the circuit components, and the exchange of data between the circuit components. The circuit design 122 models a device at a register transfer level (RTL), for example, with code in a hardware description language (HDL) such as Verilog, or Very high speed integrated circuit Hardware Design Language (VHDL), among others. In one example, the circuit design 122 may include one or more IC chips. The IC chips may be vertically stacked on top of each other into a three-dimensional (3D) IC chip device. In another example, the IC chips may be horizontally disposed on a substrate, and connected via wires on the substrate. Further, in other examples, the IC chips are vertically stacked and horizontally disposed on a substrate.

In one or more examples, the verification engine 112 includes one or more testbenches 116. The testbenches 116 are generated from the circuit design 122 and are used to define the simulations performed on the circuit design 122. A testbench 116 defines the test stimuli, for example, clock signals, activation signals, power signals, control signals, and/or data signals. The clock signal, activation signals, power signals, control signals, and/or data signals may be grouped to form testbench transactions. The testbench transactions are used to implement operation within one or more portions of the circuit design 122. In one example, the circuit design 122 includes multiple IC chips. In such an example, a testbench 116 is generated for each IC chip, and each testbench 116 implements operation of a corresponding IC chip within the circuit design. When a testbench 116 is executed, testbench components are dynamically generated for simulation of at least a portion of the circuit design 122.

A testbench 116 is written in an object-oriented programming language, for example, SystemVerilog, among others. In one or more examples, a methodology library is used to create the testbenches 116 and simulate the circuit design 122. In one or more examples, a methodology library is one of a Universal Verification Methodology (UVM) library, an Open Verification Methodology (OVM) library, an Advanced Verification Methodology (AVM) library, or a Verification Methodology Manual (VMM) library, among others. The methodology library includes instructions (e.g., code) that when executed by a processor causes the processor to perform a simulation of a corresponding portion of the circuit design 122 (e.g., an IC chip within the circuit design 122) within a simulation environment.

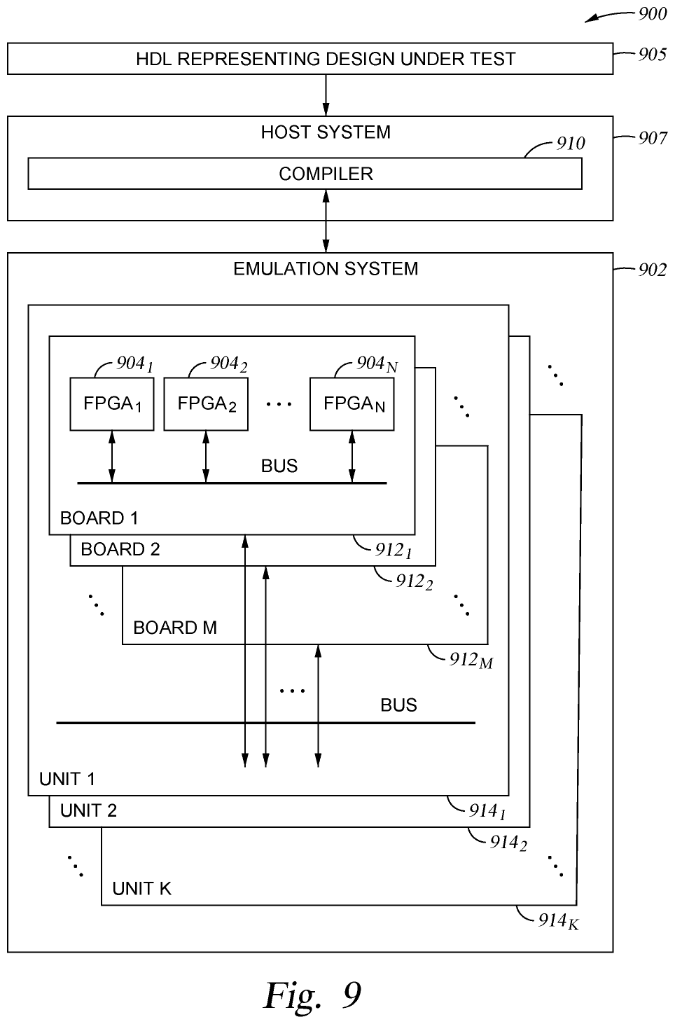

In one or more examples, the testbench engine 110 receives the testbenches 116 from an external source, such as a user interface of a computer system (e.g., computer system 1000 of FIG. 10, or host system 907 of FIG. 9), another engine within the circuit simulation system 100, and/or a system external to the circuit simulation system 100.

The verification engine 112 simulates the circuit design 122 based on the testbenches 116. A testbench environment generates a test stimulus from the testbench. The test stimuli includes vectors including clock signals, activation signals, power signals, control signals, and/or data signals, among others, that are used during the simulation of the circuit design 122. The verification engine 112 generates simulation data (e.g., simulation results) based on the test stimuli provided to the circuit design 122.

The verification engine 112 compares simulation data determined from simulations performed based on the testbenches 116 on the different partitions of the IC circuit design 122 to expected simulation data to determine the functionality of the circuit design 122. The expected simulation data is received from the memory 120 or a system external to the circuit simulation system 100. The simulation data may be in the form of waveform data, among others. In one or more examples, when the simulation data indicates that the circuit design 122 operates differently than expected based on the comparison of the simulation data to the expected simulation data a defect within the circuit design 122 is determined to be present.

The verification engine 112 compiles and links testbenches 116 with the circuit design 122. In one example, the verification engine 112 checks the circuit design 122 and the testbenches 116 for errors (e.g., syntax errors and other issues) and issues warnings accordingly. In one or more examples, the verification engine 112 identifies library components from the testbenches 116 and standardizes UVM, OVM, or AVM, among others, library components.

The verification engine 112 elaborates the testbenches 116 for simulation of the circuit design 122. Elaboration of the testbenches 116 includes instantiating objects and/or classes, among others, within each of the testbenches 116 to prepare the testbenches 116 for simulation of the circuit design 122 within the client devices 130. The verification engine 112 constructs a hierarchy for each of the testbenches 116 and a signal connectivity in each of the testbenches 116 based on the object instantiation and configuration data (information) associated with each of the testbenches 116 based on the library components.

In one or more examples, the debug engine 114 may be used to identify and isolate the defects within the circuit design 122 and to correct the defects within the circuit design 122. The debug engine 114 receives the simulation data, the expected signal data, and/or the circuit design 122 to be used to identify and correct defects within the circuit design 122.

The memory 120 may be configured similar to that of the main memory 1004 of FIG. 10 and/or the machine-readable medium 1024 of FIG. 10. The memory 120 includes the circuit design 122. In one or more examples, the testbenches 116 are stored within the memory 120. Further, the memory 120 is communicatively connected to the testbench engine 110 and the client devices 130.

The client devices 130 include client devices 130₀ through client devices 130_{N}, where N is greater than 1. Further, each of the client devices 130 may be a computer system configured similar to the computer system 1000 of FIG. 10, or host system 907 of FIG. 9. In one example, each of the client devices 130 is a respective processor of a multi-processor computer system. In other examples, each of the client devices 130 is a virtual machine. The client devices 130 are communicatively connected to the testbench engine 110 and the memory 120. The client devices 130 perform the simulation associated with the testbenches 116. In one example, each testbench 116 is simulated by a respective one of the client devices 130. For example, each client device 130 performs a simulation associated with a respective portion of the circuit design 122. In an example where a circuit design 122 includes more than one IC chips, each client device 130 performs a simulation associated with a different IC chip.

The client devices 130 simulate the circuit design 122 such that the simulation of the circuit design 122 is distributed over multiple different client devices 130. Further, the client devices simulate the different portions (e.g., different IC chips) of the circuit design 122 in parallel with each other. In one example, one of the client devices 130 (e.g., client device 130₀) is a primary client device, and one or more of the client devices 130 (e.g., client device 130₁, 130₂, and/or 130_{N}) is a secondary client device.

A primary client device controls the simulation process performed by the secondary client devices. For example, the primary client device receives simulation data generated by the secondary client devices and combines the simulation data such that simulation data can be used by the verification engine 112 and/or the debug engine 114 to determine the functionality of the circuit design 122 as described above. In one or more examples, the primary client device maintains a synchronization clock signal that is used to control the communication between each of the secondary client devices that are operating based on a respective local clock signal. In one example, the frequency of the synchronization clock signal is higher than that of the local clock signals of each of secondary client devices. In other examples, one or more of the local clock signals of the secondary client devices has a higher frequency than the synchronization clock signal.

In one example, the circuit design 122 includes multiple IC chips that are interconnected with other. In such an example, each IC chip can be simulated separately from each other by a respective secondary client device (e.g., client device 130₁-130_{N}). A primary client device (e.g., client device 130₀) controls simulations performed by the secondary client devices by combining and/or processing the simulation data provided by each secondary client device to be used by the verification engine 112 and/or the debug engine 114 to determine the functionality of the circuit design 122.

Distributed simulation of a circuit design allows for different partitions of a circuit design to be simulated in parallel with each other with different client devices. For examples, the circuit design 122 can be partitioned into multiple partitions that are simulated during at least partially overlapping periods with different client devices. In a distributed simulation process, the different simulations may start and/or end at different times. In some examples, a circuit design may include multiple different partitions (e.g., portions) that are coupled with each other. In such a circuit design, the distributed simulations are synchronized with each other to allow for data to be communicated between the simulations. For example, a primary client device may synchronize the simulations performed by client devices based on a primary clock signal (e.g., a synchronization clock signal) of the primary client device. In various examples, the primary client device aligns synchronization points for secondary client devices with rising and/or falling edges of a primary clock signal. In one or more examples, the primary client device and secondary client devices use separate write phases and read phases such that read commands performed by the primary client device occur asynchronously with write commands performed by secondary client devices.

Further, in a distributed simulation process, each secondary client device 130 performs a simulation associated with a different testbench 116 of the circuit design 122. Further, as is described in greater detail in the following, the events generated by the simulation of the different testbenches 116 occur asynchronously with each other. The events generated by the simulation of the different testbenches 116 are also asynchronous with a synchronization clock signal. In such examples, the primary client device uses read commands aligned with the primary clock signal to synchronously receive the simulation data associated with the completed testbench events to synchronously receive the simulation data from the secondary client devices.

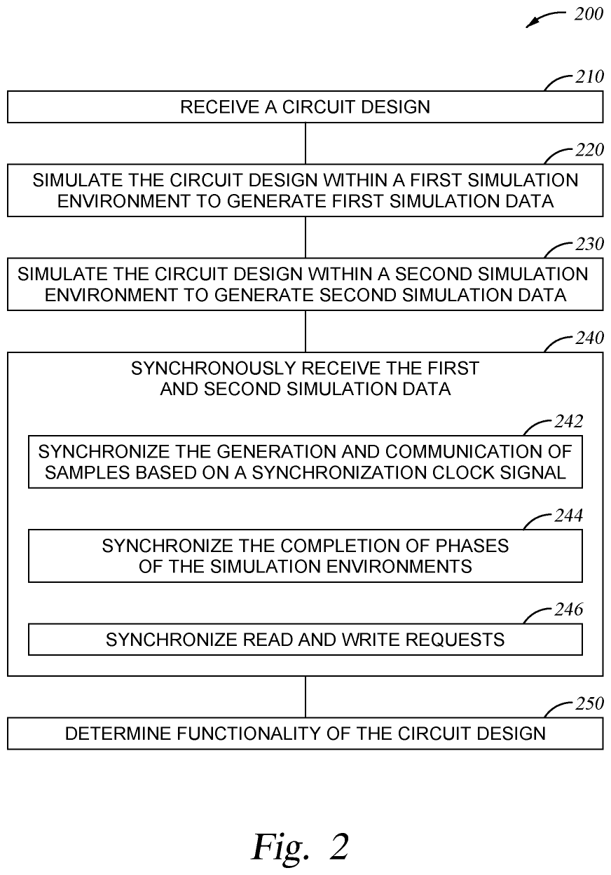

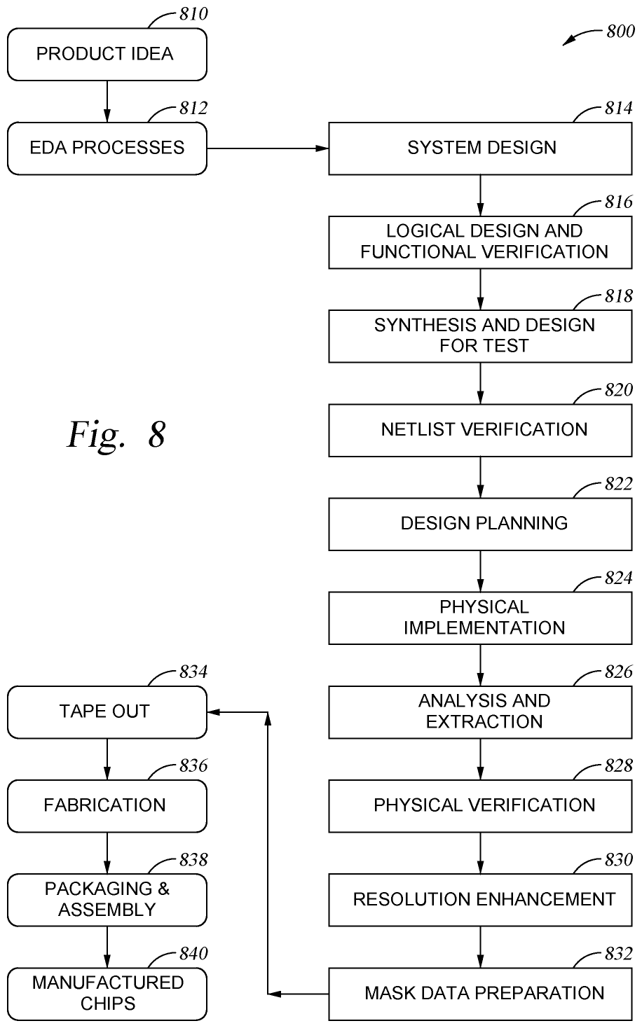

FIG. 2 illustrates a flowchart of a method 200 for distributed simulation of the circuit design 122 according to one or more examples. The method 200 is performed by the circuit simulation system 100 of FIG. 1. For example, one or more processors of the circuit simulation system 100 executes instructions stored in a memory to perform the method 200. The method 200 is performed as part of the process logical design and functional verification 816 of FIG. 8. In one or more examples, the method 200 allows for the distributed simulations performed by respective client devices 130 to use a respective local clock signal, and a primary clock signal to communicate the simulation data from the different simulations between client devices and/or between the client devices and a primary client device. Accordingly, read and write phases may be disjointed (e.g., unaligned) from each other as the read and write commands are issued based on a local clock signal or a primary clock signal. In one or more examples, performing the method 200 synchronizes the phases of the different simulations by waiting until each simulation completes a similar phase. In one example, performing the method 200 allows for write commands and read commands of the secondary client devices to be asynchronous. The write commands are issued synchronously with a local clock signal and the read commands are issued synchronously with the primary clock signal.

At 210 of the method 200, the circuit simulation system 100 receives the circuit design 122. In one or more examples, the testbench engine 110 receives the circuit design 122 from the memory 120, from another engine of the circuit simulation system 100, or from a system external to the circuit simulation system 100. The circuit design 122 may be referred to as a design under test (DUT).

The circuit design 122 includes a configuration file 124 includes configuration data (information) that defines the different simulations of a distributed simulation process. For example, the configuration data of the configuration file 124 identifies a local clock signal for each simulation. The configuration data of the configuration file 124 further identifies a primary clock signal and/or a synchronization time interval that is used to synchronize the communication of the simulation data between a primary client device (e.g., the client device 130₀) and the salve client devices (e.g., the client device 130₁ and the client device 130₂), and further between secondary client devices (e.g., the client device 130₁ and the client device 130₂).

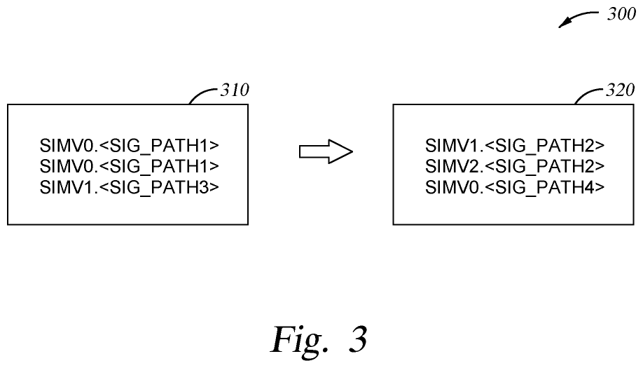

The configuration data of the configuration file 124 further identifies connections between simulations within the circuit design 122. For example, FIG. 3 illustrates connections 300 of a circuit design (e.g., the circuit design 122 of FIG. 1). The connections 300 include connections between sampling processes 310 and driving processes 320. During the sampling processes 310, one or more loads (e.g., circuit elements) of a simulation are sampled to generate sampled values. During the driving processes 320, the drive signals are driven based on the sampled values obtained during the sampling processes 310.

As illustrated in FIG. 3, the signal path 1 (sig_path1) of simulation 0 (SIMV0) (e.g., SIMV0<sig_path1>) in the sampling processes 310 is connected with signal path 2 (sig_path2) of simulation 1 (SIMV1) (e.g., SIMV1<sig_path2>) in the driving processes 320. Accordingly, data sampled that is associated with the signal path 1 is provided to the signal path 2 of simulation 1 to be used during the corresponding drive phase. Further, the configuration file identifies that the signal path 1 of simulation 0 (e.g., SIMV0<sign_path1>) in the sampling processes 310 is also connected with signal path 2 of simulation 2 (SIMV2) (e.g., SIMV2<sig_path2>) in the driving processes 320. The connections 300 further identify that the signal path 3 (sig_path3) of simulation 1 (e.g., SIMV1<sign_path3>) is connected with signal path 4 (sig_path4) of simulation 0 (e.g., SIMV0<sig_path4>). In other examples, a signal path of a first simulation may be connected to signal paths of two or more other simulations.

Referring to FIG. 2, at 220 of the method 200, the circuit design 122 is simulated in a first simulation environment to generate first simulation data. With reference to FIG. 1, the first simulation environment is associated with the client device 130₁ and corresponds to a first testbench 116 and a first portion of the circuit design 122. The client device 130₁ is a secondary client device. The first portion of the circuit design 122 corresponds to a first IC chip or another portion of the circuit design 122. In one example, generating first data using a first simulation environment includes performing multiple phases associated with the corresponding testbench. The test phases correspond to the methodology library is used to create the testbenches 116. For example, the test phases may be UVM phases, OVM phases, AVM phases, or VMM phases, among others. In one example, the phases are defined by an administrator or designer of the circuit design 122. The phases define the test (e.g., simulations) to be performed. In one example, the phases are synchronization mechanisms for the testbench components. The phases are represented by callback methods. A set of predefined phases and corresponding callbacks are provided in the testbench components. The methods are either functions or tasks performed by a testbench.

Further, during the first simulation environment, the secondary client device 130₁ generates samples while driving values and signals onto the first portion of the circuit design 122 to complete each phase of the first simulation as defined by the second testbench 116. The samples are generated by applying one or more values and signals to circuit elements of the first portion of the circuit design 122. The values and signals applied to the circuit elements of the first portion of the circuit design 122 are defined by a first testbench of the testbenches 116.

At 230 of the method 200, the circuit design 122 is simulated in a second simulation environment to generate second simulation data. With reference to FIG. 1, the second simulation environment is associated with the client device 130₂. The client device 130₂ is a secondary client device. The second simulation environment is associated with a second testbench of the testbenches 116 and a second portion of the circuit design 122. The second portion of the circuit design 122 corresponds to a second IC chip or another portion of the circuit design 122. In one example, generating the second data using a second simulation environment includes performing multiple phases associated with the corresponding testbench 116. The test phases corresponds to the methodology library is used to create the testbenches 116. For example, the test phases may be UVM phases, OVM phases, AVM phases, or VMM phases, among others. In one example, the methodology associated with the second simulation environment is the same methodology that is associated with the first simulation environment. The phases define the test (e.g., simulations) to be performed during the second simulation environment.

Further, during the second simulation environment, the secondary client device 130₂ generates samples while driving values and signals onto the second portion of the circuit design 122 to complete each phase of the second simulation as defined by the second testbench 116. The samples are generated by applying one or more values and signals to circuit elements of the second portion of the circuit design 122. The values and signals applied to the circuit elements of the second portion of the circuit design 122 are defined by a second testbench of the testbenches 116.

At 230 of the method 200, the client device 130₀ synchronously receives the first and second simulation data from the client devices 130₁ and 130₂. For example, the client device 130₀ synchronously receives the first and second simulation data based on a primary clock signal, at the completion of phases associated with the different simulations, and/or controls the communication between the client devices 130₁ and 130₂ based on the primary clock signal.

In one example, synchronously receiving first and second simulation data includes 242 of the method 200, synchronizing the generation and communication of samples based on a primary clock signal (e.g., a synchronization clock signal). In one example, the client device 130₁ generates the first simulation data based on a first local clock signal, and the client device 130₂ generates the second simulation data based on a second local clock signal. The first and second client devices 130₁ and 130₂ generate respective simulation data asynchronously with a primary clock signal (e.g., synchronization clock signal) of the client device 130₀ and each other. The client device 130₀ communicates with the client devices 130₁ and 130₂ based on the primary clock signal. The first local clock signal is independent from the second local clock signal, and the first and second local clock signals are independent from the primary clock signal.

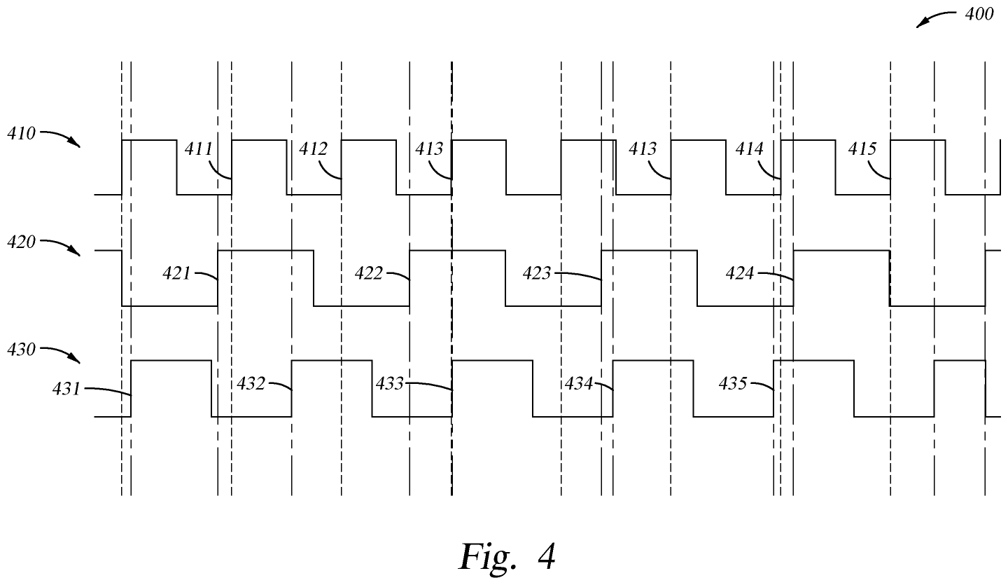

FIG. 4 illustrates waveforms 400, including the waveform of the primary clock signal 410, the first local clock signal 420, and the second local clock signal 430. As illustrated in FIG. 4, the primary clock signal 410, the first local clock signal 420, and the second local clock signal 430 are unaligned (e.g., asynchronous) with each other. For example, the frequency of the primary clock signal 410 is greater than the frequency of the first local clock signal 420 and the second local clock signal 430. Further, the frequency of the second local clock signal 430 is greater than the frequency of the first local clock signal 420.

The client device 130₀ receives sampled values from the client device 130₁ and the client device 130₂ at rising edges of the primary clock signal 410. Further, the client device 130₁ and the client device 130₂ generate sample values at rising edges of the first local clock signal 420 and the second local clock signal 430, respectively. In one example, the client device 130₁ generates samples associated with the first simulation environment at rising edge 421 of the first local clock signal 420. Further, the client device 130₂ generates samples associated with the second simulation environment at rising edge 431 of the second local clock signal 430. The client device 130₀ receives (e.g., obtains) the samples generated during the rising edges 421 and 431 at the rising edge 411 of the primary clock signal 410. Accordingly, the samples generated during the edges 421 and 431 are generated asynchronously with each other and asynchronously with the primary clock signal 410.

The rising edge 421 of the first local clock signal 420 is unaligned with the rising edge 431 of the second local clock signal 430, and the rising edge 421 of the first local clock signal 420 is unaligned with the rising edge 411 of the primary clock signal 410.

The client device 130₂ further generates samples associated with the second simulation environment at rising edge 432 of the second local clock signal 430. The client device 130₀ receives (e.g., obtains) the samples generated at the rising edge 432 at the rising edge 412 of the primary clock signal 410. The rising edge 433 of the second local clock signal 430 is unaligned with the rising edge 412 of the primary clock signal 410.

The client device 130₁ further generates samples associated with the first simulation environment at rising edge 422 of the first local clock signal 420. The client device 130₂ generates samples associated with the second simulation environment at rising edge 433 of the second local clock signal 430. The client device 130₀ receives (e.g., obtains) the samples generated at the rising edges 422 and 433 at the rising edge 413 of the primary clock signal 410. The rising edge 422 of the first local clock signal 420 and the rising edge 433 of the second local clock signal 430 are unaligned with the rising edge 413 of the primary clock signal 410.

The client device 130₁ further generates samples associated with the first simulation environment at rising edge 423 of the first local clock signal 420. The client device 130₂ generates samples associated with the second simulation environment at rising edge 434 of the second local clock signal 430. The client device 130₀ receives (e.g., obtains) the samples generated at the rising edges 423 and 434 at the rising edge 414 of the primary clock signal 410. The rising edge 423 of the first local clock signal 420 and the rising edge 434 of the second local clock signal 430 are unaligned with the rising edge 414 of the primary clock signal 410.

The client device 130₂ further generates samples associated with the second simulation environment at rising edge 445 of the second local clock signal 430. The client device 130₀ receives the samples generated during the rising edge 435 at the rising edge 415 of the primary clock signal 410. The rising edge 435 of the second local clock signal 430 is unaligned with the rising edge 415 of the primary clock signal 410.

The client device 130₁ further generates samples associated with the first simulation environment at rising edge 424 of the first local clock signal 420. The client device 130₀ receives the samples generated during the rising edge 424 at the rising edge 416 of the primary clock signal 410. The rising edge 424 of the first local clock signal 420 is unaligned with the rising edge 416 of the primary clock signal 410.

FIG. 4 illustrates an example where sampled values generated during different simulation environments are asynchronous with each other and asynchronous with a primary clock signal of a primary client device. In other examples, a time delay may be used instead of the primary clock signal to receive sampled values. For example, sampled values obtained during the rising edge 413 of the first local clock signal and sampled values obtained during the rising edge 415 of the second local clock signal are communicated to the primary client device “X” ms after the sampled values are obtained, where X is a value greater than 0. Accordingly, in one or more examples, the client device 130₀ synchronously receives sampled data from the client devices 130₁ and 130₂.

Referring to FIG. 2, in various examples, synchronously receiving the first and second simulation data at 240 of the method 200, additionally, or alternatively, includes 244 of the method 200, synchronizing the completion of phases associated with the different testbenches 116 executed by the client devices 130. In one example, the client device 130₁ and the client device 130₂ executes phases UVM_P1, UVM_P2, UVM_P3, UVM_P4, USR_P1, and USR_P2, among others. The phases of a testbench are functional phases that correspond to reset phases and data transfer phases, among others.

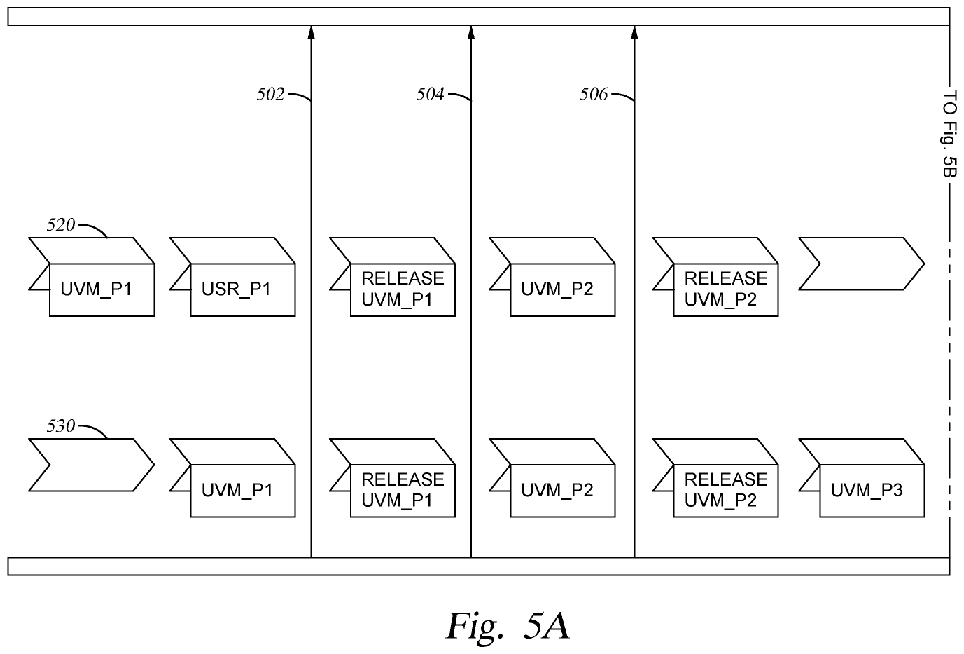

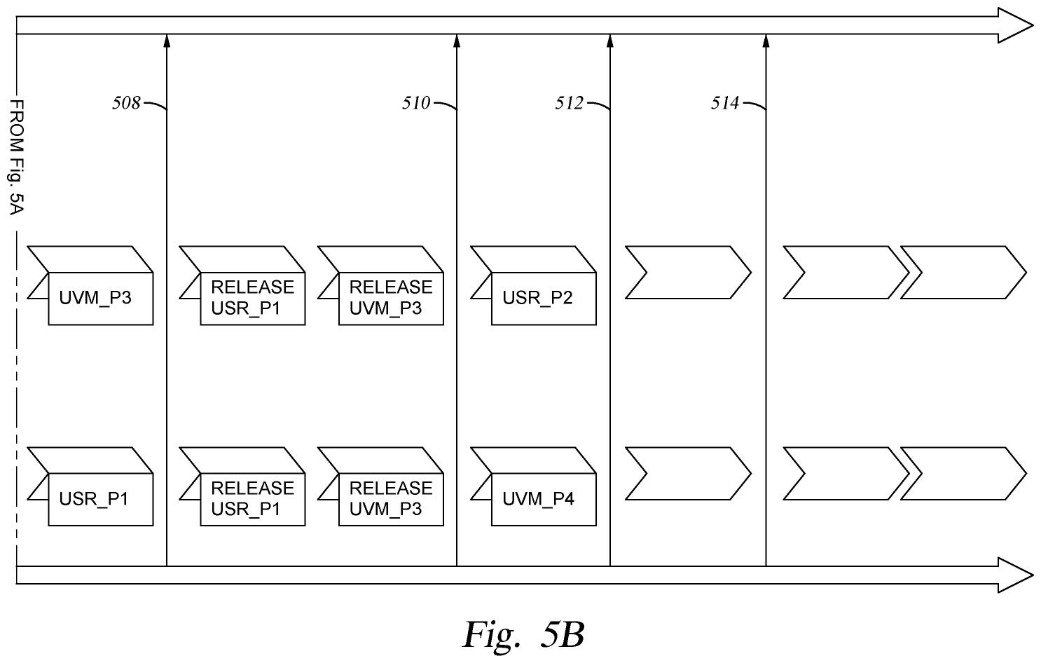

FIG. 5A and FIG. 5B illustrate phase diagrams 520 and 530 associated with the client devices 130₁ and 130₂, respectively. The phase diagrams 520 and 530 illustrate the respective plurality of phases and the phase completions of each of the plurality of phases of the phase diagrams 520 and 530. Further, FIG. 5A and FIG. 5B illustrates synchronization points 502-514. The phases of the phase diagrams 520 and 530 are asynchronous with each other. The synchronization points 502-514 correspond to points during which the phases of each phase diagrams 520 and 530 are synchronized with each other by a client device 130₀.

The testbenches 116 associated with the client devices 130₁ and 130₂ include a wait command associated with a phase or phases (e.g., UVM_P1 and/or UVM_P2) that instructs the client device 130₁ and 130₂ not to communicate the generated simulation data associated with a phase until all client devices have completed execution of that phase. The testbenches 116 identify which phases are associated with wait commands and which wait commands are not associated with wait commands. In one or more examples, the wait commands mitigate race conditions and simultaneous writes in the various simulations.

In one or more examples, class objects are transferred across simulations, by streaming, to distribute the testbench, or testbenches, 116. In one or more examples, in a hardware description language (HDL) streaming method, the contents of a class object are stored into a vector. The vector is transmitted to and from the testbenches 116. The vector is received and translated to a class object.

In one or more examples, to maintain the determinism in the data transfer to and from testbenches 116, the testbenches 116 include “wait” commands, as described above.

The client device 130₁ completes the phase UVM_P1 followed by the phase USR_P1, and the client device 130₂ completes the phase UVM_P1 after the client device 130₁ completes the phase UVM_P1. The client device 130₂ completes the phase UVM_P1 synchronous with the phase USR_P1. As the phase UVM_P1 is completed by the client device 130₁ before the client device 130₂ completes the phase UVM_P1, the client device 130₁ waits to communicate the simulation data corresponding to the phase UVM_P1 until the client device 130₂ completes the phase UVM_P1. Accordingly, at synchronization point 502, the client devices 130₁ and 130₂ communicate the simulation data associated with the phase UVM_P1 to the client device 130₀.

In one example, the client device 130₀ determines that at the synchronization point 502 the client devices 130₁ and 130₂ have both completed the phase UVM_P1. Accordingly, at the synchronization point 502 and based on determining that the client devices 130₁ and 130₂ having completed the phase UVM_P1, the client device 130₀ obtains corresponding simulation data from each of the client devices 130₁ and 130₂. In one example, each of the testbenches 116 associated with the client devices 130₁ and 130₂ includes a wait command associated with the phase UVM_P1 that instructs the client device 130₁ and 130₂ not to communicate corresponding simulation data until all client devices have completed execution of the phase UVM_P1.

At synchronization point 504, both of the client devices 130₁ and 130₂ have completed the phase Release UVM_P1, and associated simulation data is communicated from the client devices 130₁ and 130₂ to the client device 130₀ at synchronization point 504.

As each of the client devices 130₁ and 130₂ completes the phase Release UVM_P1 at the same time, the corresponding simulation data is released without the completion of a wait period.

At synchronization point 506, both of the client devices 130₁ and 130₂ have completed the phase UVM_P2, and associated simulation data is communicated from the client devices 130₁ and 130₂ to the client device 130₀ at synchronization point 506.

At the synchronization point 508, both of the client devices 130₁ and 130₂ have completed the phases Release UVM_P2, USR_P1, and UVM_P3. As the client device 130₁ completed the phase USR_P1 before completing Release UVM_P2 and before the client device 130₂ completed the phases Release UVM_P2 and UVM_P3, at the synchronization point 508, the simulation data associated with the phase USR_P1 is communicated from the client devices 130₁ and 130₂ to the client device 130₀. As illustrated in FIG. 5A and FIG. 5B, the client devices 130₁ and 130₂ complete the phase USR_P1 asynchronously with each other.

At the synchronization point 510, both of the client devices 130₁ and 130₂ have completed phases Release UVM_P2, UVM_P3, Release USR_P1 and Release UVM_P3. Accordingly, as the client devices 130₁ and 130₂ completed the phase Release UVM_P2 before both client devices completed the other phases, at the synchronization point 510, the simulation data associated with the Release UVM_P2 is communicated from the client devices 130₁ and 130₂ to the client device 130₀.

At the synchronization point 512, the simulation data associated with the phase UVM_P3 is communicated from the client devices 130₁ and 130₂ to the client device 130₀. The client devices 130₁ and 130₂ complete the phase UVM_P3 before the client devices 130₁ and 130₂ complete the phases Release USR_P1 and Release UVM_P3, at the synchronization point 512, the simulation data associated with the phase UVM_P3 is communicated from the client devices 130₁ and 130₂ to the client device 130₀.

At the synchronization point 514, the simulation data associated with the phase Release USR_P1 is communicated from the client devices 130₁ and 130₂ to the client device 130₀. The client devices 130₁ and 130₂ complete the phase Release USR_P1 before the client devices 130₁ and 130₂ complete the phase Release UVM_P3, at the synchronization point 512, the simulation data associated with the phase Release USR_P1 is communicated from the client devices 130₁ and 130₂ to the client device 130₀.

In one example, at each synchronization point, simulation data associated with a single phase is communicated from the client devices 130₁ and 130₂ to the client device 130₀, as is described above. In other examples, at one or more synchronization points, simulation data associated with more than one phase may be communicated from the client devices 130₁ and 130₂ to the client device 130₀. For example, at the synchronization point 510, as both the phases Release USR_P1 and Release UVM_P3 have been completed, simulation data associated with both of the phases Release USR_P1 and Release UVM_P3 is communicated the client devices 130₁ and 130₂ to the client device 130₀.

With further reference to the method 200 of FIG. 2, synchronously receiving the first and second simulation data at 240 of the method 200, additionally, or alternatively, includes 246 of the method 200, synchronizing read and write requests between simulation environments (e.g., client devices).

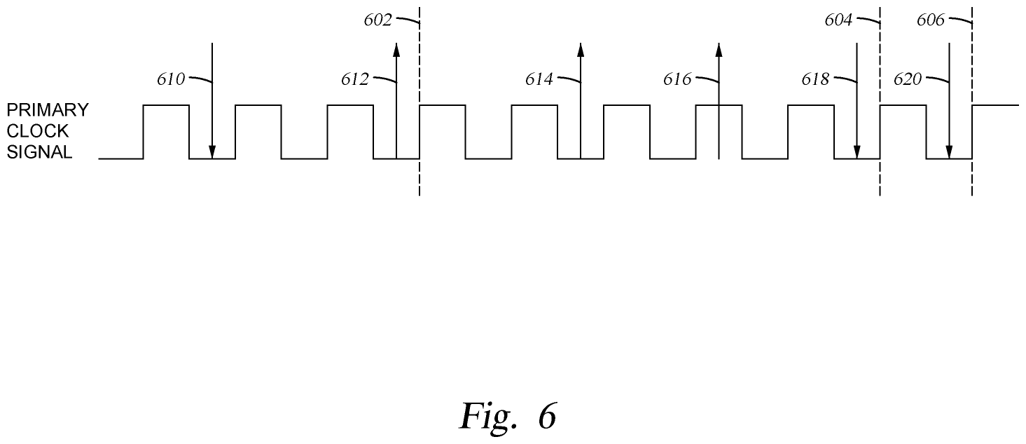

FIG. 6 illustrates read and write requests of the client devices 130₁ and 130₂ with reference to the primary clock signal. The read and write requests are for reading and writing simulation data between client devices 130. For example, the read and write requests communicate simulation data between the client device 130₁ running a first simulation and the client device 130₂ running a second simulation environment, and the client device 130₀. In one example, the client device 130₀ reads data from the client devices 130₁ and 130₂. Further, the client devices 130₁ and 130₂ writes data to the client device 130₀. The primary clock signal includes read requests 610, 618, and 620 from the client device 130₁ and write requests 612, 614, and 616 from the client device 130₂. In one example, the client device 130₁ issues the read request 610. The client device 130₀ holds (e.g., delays) the read command until the write request 612 is issued by the client device 130₂. The read and write requests 610 and 612 correspond to a first communication channel associated with respective portions of the circuit design 122. At the rising edge 602 of the primary clock signal, data is sent from the client device 130₁ to the client device 130₂ based on the read and write requests 610 and 612. The read and write requests 610 and 612 are serviced at the next occurring rising edge of the primary clock signal such that servicing of the read and write requests 610 and 612 are synchronous with the primary clock signal. Further, the client device 130₂ issues write requests 614 and 616 and the client device 130₁ issues read requests 618 and 620. The write requests 614 and 616 and the read requests 618 and 620 are associated with a second communication channel associated with respective portions of the circuit design 122. The write request 614 and the read requests 618 are serviced at the rising edge 604 of the primary clock signal. Further, the write request 616 and the read request 620 are serviced at the rising edge 606 of the primary clock signal.

With further reference to method 200 of the FIG. 2, at 250 of the method 200, the functionality of the circuit design 122 is determined. In one example, the client device 130₀ combines the simulation data received from the client devices 130₁ and 130₂. The combined simulation data is stored in the memory 120 and/or communicated to the verification engine 112. The verification engine 112 compares the simulation data to expected values to determine the functionality of the circuit design 122. For example, the verification engine 112 compares the simulation data to the expected values to determine whether or not functionality defects exist within the circuit design 122. Defects may be stored within the memory 120 and/or communicated an administrator and/or design for correction or other action.

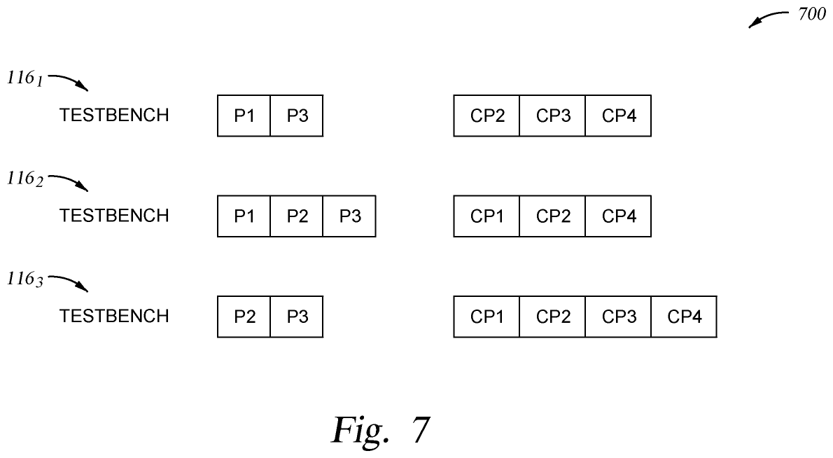

FIG. 7 illustrates phases 700 associated with three testbenches 116 (e.g., testbench 116₁, testbench 116₂, and testbench 116₃). The testbench 116₁ includes phases P1, P3, CP2, CP3, and CP4. The testbench 116₂ includes phases P1, P2, P3, CP1, CP2, and CP4. The testbench 116₃ includes phases P2, P3, CP1, CP2, CP3, and CP4. In one or more examples, the testbench engine 110 determines which phases of the testbenches 116₁, 116₂, and 116₃ are included in two or more of the testbenches 116₁, 116₂, and 116₃. In one example, the testbench engine 110 determines which phases of the testbenches 116₁, 116₂, and 116₃ are included each of the testbenches 116₁, 116₂, and 116₃. The phases that are determined to not be included in two or more of the testbenches 116₁, 116₂, and 116₃ may be excluded from having wait commands as described above with regard to FIG. 5A and FIG. 5B. For example, if a wait command is applied to phase in only one of the testbenches 116₁, 116₂, and 116₃, the phase may cause an unexpected pause within the simulation of one or more the testbenches 116₁, 116₂, and 116₃. For example, if phase P1 was present in testbench 116₁, and not in testbenches 116₂ and 116₃, and a wait command is inserted within the phase P1, at the completion of the phase P1, the testbench 116₁ waits until one or more of the testbenches 116₂ and 166₃ has completed the phase P1. However, in this example, as the testbenches 116₂ and 166₃ do not include the phase P1, the testbench 116₁ does not receive an indication that one or more of the testbenches 116₂ and 166₃ has completed the phase P1, and an unexpected pause occurs within the testbench 116₁. Accordingly, in such an example, the simulation data associated with phase P1 is not be communicated. The pause of a phase corresponds to unexpected delay. In one or more examples, to avoid any phases from pausing, the testbench engine 110 determines which of the phases of phases 700 are not included in two or more of the testbenches 116₁, 116₂, and 116₃. For any phases that are not determined to be in two more of the testbenches 116₁, 116₂, and 116₃, wait commands are not applied to those phases. In one examples, the configuration file 124 specifies the applicable phases for each of the simulations (e.g., testbenches 116).

In one or more examples, the testbench engine 110 inserts wait commands into the phases that are included in each of the testbenches 116₁, 116₂, and 116₃. For example, the testbench engine 110 inserts a wait command in the phases P3, CP2, and CP4.

FIG. 8 illustrates an example set of processes 800 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 810 with information supplied by a designer, information which is transformed to create an article of manufacture that uses a set of EDA processes 812. When the design is finalized, the design is taped-out 834, which is when artwork (e.g., geometric patterns) for the integrated circuit is sent to a fabrication facility to manufacture the mask set, which is then used to manufacture the integrated circuit. After tape-out, a semiconductor die is fabricated 836 and packaging and assembly processes 838 are performed to produce the finished integrated circuit 840.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 9. The processes described by be enabled by EDA products (or EDA systems).

During system design 814, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 816, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 818, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 820, the netlist is checked for compliance with timing constraints and for correspondence with the HDL code. During design planning 822, an overall floor plan for the integrated circuit is constructed and analyzed for timing and top-level routing.

During layout or physical implementation 824, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 826, the circuit function is verified at the layout level, which permits refinement of the layout design. During physical verification 828, the layout design is checked to ensure that manufacturing constraints are correct, such as DRC constraints, electrical constraints, lithographic constraints, and that circuitry function matches the HDL design specification. During resolution enhancement 830, the geometry of the layout is transformed to improve how the circuit design is manufactured.

During tape-out, data is created to be used (after lithographic enhancements are applied if appropriate) for production of lithography masks. During mask data preparation 832, the ‘tape-out’ data is used to produce lithography masks that are used to produce finished integrated circuits.

A storage subsystem of a computer system (such as computer system 1000 of FIG. 10, or host system 907 of FIG. 9) may be used to store the programs and data structures that are used by some or all of the EDA products described herein, and products used for development of cells for the library and for physical and logical design that use the library.

FIG. 9 depicts a diagram of an example emulation environment 900. An emulation environment 900 may be configured to verify the functionality of the circuit design. The emulation environment 900 may include a host system 907 (e.g., a computer that is part of an EDA system) and an emulation system 902 (e.g., a set of programmable devices such as Field Programmable Gate Arrays (FPGAs) or processors). The host system generates data and information by using a compiler 910 to structure the emulation system to emulate a circuit design. A circuit design to be emulated is also referred to as a design under test (‘DUT’) where data and information from the emulation are used to verify the functionality of the DUT.

The host system 907 may include one or more processors. In the embodiment where the host system includes multiple processors, the functions described herein as being performed by the host system can be distributed among the multiple processors. The host system 907 may include a compiler 910 to transform specifications written in a description language that represents a DUT and to produce data (e.g., binary data) and information that is used to structure the emulation system 902 to emulate the DUT. The compiler 910 can transform, change, restructure, add new functions to, and/or control the timing of the DUT.

The host system 907 and emulation system 902 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 902.11. The host system 907 and emulation system 902 can exchange data and information through a third device such as a network server.

The emulation system 902 includes multiple FPGAs (or other modules) such as FPGAs 904₁ and 904₂ as well as additional FPGAs to 904_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 902 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 904₁-904_{N} may be placed onto one or more boards 912₁ and 912₂ as well as additional boards through 912_{M}. Multiple boards can be placed into an emulation unit 914₁. The boards within an emulation unit can be connected using the backplane of the emulation unit or any other types of connections. In addition, multiple emulation units (e.g., 914₁ and 914₂ through 914_{K}) can be connected to each other by cables or any other means to form a multi-emulation unit system.

For a DUT that is to be emulated, the host system 907 transmits one or more bit files to the emulation system 902. The bit files may specify a description of the DUT and may further specify partitions of the DUT created by the host system 907 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 907 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 907 and/or the compiler 910 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 905 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1002 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense. cm What is claimed is:

1. A method comprising:
receiving a circuit design;
simulating, by a first client device, a first portion of the circuit design within a first simulation environment to generate first simulation data;
simulating, by a second client device, a second portion of the circuit design within a second simulation environment to generate second simulation data, wherein the first simulation data and the second simulation data are generated asynchronously with each other; and
receiving, at a primary client device, the first simulation data and the second simulation data synchronously with each other, wherein functionality of the circuit design is determined based on the first simulation data and the second simulation data.

2. The method of claim 1, wherein the circuit design includes configuration data including a first local clock signal of the first simulation environment, and a second local clock signal of the second simulation environment.

3. The method of claim 2, further comprising:
generating, by the first client device, first sampled values of the first simulation data based on the first local clock signal; and
generating, by the second client device, second sampled values of the second simulation data based on the second local clock signal, wherein the first sampled values and the second sampled values are generated asynchronously with each other.

4. The method of claim 3, wherein the configuration data further includes a primary clock signal, and wherein the primary client device issues a read command to receive the first sampled values and the second sampled values based on the primary clock signal.

5. The method of claim 1, further comprising:
completing, by the first client device, a first plurality of phases within the first simulation environment; and
completing, by the second client device, a second plurality of phases within the second simulation environment, wherein the first plurality of phases and the second plurality of phases each comprise a first phase, and wherein the first phase is completed asynchronously within the first plurality of phases and the second plurality of phases.

6. The method of claim 5, further comprising obtaining, by the primary client device, the first simulation data from the first client device and the second simulation data from the second client device based on the completion of the first phase by both of the first client device and the second client device.

7. The method of claim 1, wherein the primary client device comprises a primary clock signal and is further configured to receive a receive request from the first client device asynchronously with the primary clock signal and a send request from the second client device asynchronously with the primary clock signal, and wherein a data transfer associated with the receive request and the send request is executed at a rising edge of the primary clock signal.

8. A system comprising:
a first client device configured to simulate a first portion of a circuit design within a first simulation environment to generate first simulation data;
a second client device configured to simulate a second portion of the circuit design within a second simulation environment to generate second simulation data, wherein the first simulation data and the second simulation data are generated asynchronously with each other; and
a third client device configured to receive the first simulation data and the second simulation data from the first client device and the second client device synchronously with each other, and wherein functionality of the circuit design is determined based on the first simulation data and the second simulation data.

9. The system of claim 8, wherein the circuit design includes configuration data including a first local clock signal of the first simulation environment, and a second local clock signal of the second simulation environment.

10. The system of claim 9, wherein the first client device is further configured to generate first sampled values of the first simulation data based on the first local clock signal, and the second client device is further configured to generate second sampled values of the second simulation data based on the second local clock signal, wherein the first sampled values and the second sampled values are generated asynchronously with each other.

11. The system of claim 10, wherein the configuration data further includes a primary clock signal, and wherein the third client device issues a read command to receive the first sampled values and the second sampled values based on the primary clock signal.

12. The system of claim 8, wherein the first client device is configured to complete a first plurality of phases within the first simulation environment and the second client device is configured to complete a second plurality of phases within the second simulation environment, wherein the first plurality of phases and the second plurality of phases each comprise a first phase, and wherein the first phase is completed asynchronously within the first plurality of phases and the second plurality of phases.

13. The system of claim 12, wherein the third client device is configured to obtain the first simulation data from the first client device and the second simulation data from the second client device based on the completion of the first phase by both of the first client device and the second client device.

14. The system of claim 8, wherein the third client device comprises a primary clock signal and is further configured to receive a receive request from the first client device asynchronously with the primary clock signal and a send request from the second client device asynchronously with the primary clock signal, and wherein a data transfer associated with the receive request and the send request is executed at a rising edge of the primary clock signal.

15. A non-transitory computer readable medium comprising stored instructions, which when executed by one or more processors, cause the one or more processors to:
receive a circuit design including a first local clock signal, and a second local clock signal, and a primary clock signal;
simulate a first portion of the circuit design within a first simulation environment to generate first simulation data based on the first local clock signal;
simulate a second portion of the circuit design within a second simulation environment to generate second simulation data based on the second local clock signal; and
receive the first simulation data and the second simulation data synchronously with each other and based on the primary clock signal, wherein the first simulation data and the second simulation data are generated asynchronously with the primary clock signal and each other, and wherein functionality of the circuit design is determined based on the first simulation data and the second simulation data.

16. The non-transitory computer readable medium of claim 15, wherein the one or more processors is further caused to generate first sampled values of the first simulation data based on the first local clock signal, and to generate second sampled values of the second simulation data based on the second local clock signal, wherein the first sampled values and the second sampled values are generated asynchronously with each other.

17. The non-transitory computer readable medium of claim 16, wherein the one or more processors is further caused to issue a read command to receive the first sampled values and the second sampled values based on the primary clock signal.

18. The non-transitory computer readable medium of claim 15, wherein the one or more processors is further caused to complete a first plurality of phases within the first simulation environment and a second plurality of phases within the second simulation environment, wherein the first plurality of phases and the second plurality of phases each comprise a first phase, and wherein the first phase is completed asynchronously within the first plurality of phases and the second plurality of phases.

19. The non-transitory computer readable medium of claim 18, wherein the one or more processors is further caused to obtain the first simulation data and the second simulation data based on the completion of the first phase within both of the first simulation environment and the second simulation environment.

20. The non-transitory computer readable medium of claim 15, wherein the one or more processors is further caused to receive a receive request associated with the first simulation data asynchronously with the primary clock signal and a send request associated with the second simulation data asynchronously with the primary clock signal, and wherein a data transfer associated with the receive request and the send request is executed at a rising edge of the primary clock signal.
